(19) United States
(12) Patent Application Publication
(10) Pub. No.: US 2005/0263069 A1
(43) Pub. Date: Dec. 1, 2005

(54) Automatic label canceling system

(76) Inventors: Robert Dana Lundahl, Frederick, MD (US); Robert Wesley Cutlip, Millersville, MD (US)

Correspondence Address: HungChang LIN, 8 Schindler Ct., Silver Spring, MD, 20903, US

(21) Appl. No.: 10/991,222

(22) Filed: Nov. 18, 2004

Related U.S. Application Data
(60) Provisional application No. 60/524,430, filed on Nov. 24, 2003.

(51) Int. Cl. B65C 1/00; B05C 11/00

(52) U.S. Cl. 118/712; 118/713; 118/696

(57) ABSTRACT

The design of this machine presents a simple and low cost solution for automatically canceling old labels and barcodes on packages. The unique design enables the machine to be completely independent from the conveying surface by locating labels with image processing and canceling with ink jets or other marking technologies which can be performed while the package is in motion.

### BACKGROUND OF THE INVENTION

1. Field of the Invention

This invention relates to an automated machine to automatically find and cancel labels on packages on a conveyor.

2. Brief Description of Related Art

The US Postal Service and other shipping/fulfillment companies package letters and customer goods in a trays or boxes with unique labels and barcode identification. The label and markings are used to identify the package and provide information as to the delivery address, method of shipment, contents, etc. This information can be written as text or in several different barcode formats and the label is generally applied to the top of the package itself.

Many operations are now finding the need to re-use their shipping packages and serious routing problems have been created when the old labels have not been removed. Many of these operations require a person to watch for old labels and physically remove them or make them unreadable by marking them over with a heavy line marker or applying a blank label to cover the machine readable information. All of these approaches work. However, the current methods are inefficient, they are labor intensive and they are expensive since they require full time staffing in order to not miss a single label.

### SUMMARY OF THE INVENTION

The object of this invention is to design an automated device which is mounted adjacent to a conveyor to automatically find and cancels labels on packages. The design for this machine is a unique combination of commercial equipment which results in a very cost effective solution to this automation problem

The subject of this invention is a small and portable device to cancel labels or tags on re-used shipping containers. This automated machine automatically locates labels on packages and selectively activate ink-jet sprayers to render the labels unreadable for subsequent processing equipment. This machine is designed to be rolled up and positioned adjacent to a conveyor or other tray transport system. The head of the machine is positioned over the conveying surface and at a height which permits parcels to pass underneath. Inside the head is an optical scanner, which looks for barcode or label information on the top surface of the package as it passes underneath. If and when label information is found, its transverse position across the conveying surface is determined based on the relationship of when information is detected in the optical scan, which similarly sweeps across LIC conveying surface. Repetitive scans across the conveying surface locate all remaining label information.

An electronic control module interfaces to the optical scanner, package presence sensors, and controls the electronic triggers for an array of ink jet sprayers, lasers, or other marker technology arranged in a linear array across the conveying surface. The electronics controls activate the correctly positioned marker for each tag detected on the package.

The timing and duration of the marking process is determined by the control system. The marker array is positioned slightly downstream from the laser scan line. In this fashion, each marker is activated when the scan line detects label data and turned off when there label data is no longer detected. The control system allows for a certain delay to adjust any overlaps or labels and/or markings. An overall time-out is included in the SW to suspend operations should a tray become stopped under the machine.

### BREIF DESCRIPTION OF THE DRAWINGS

FIG. (1) illustrates the overall configuration of the machine and its operating position relative to a conveyor and transport package.

FIG. (2) provides a more detailed look at the components of the scanning head module (1) and how they operate to automatically cancel package labels.

### DETAILED DESCRIPTION OF THE INVENTION

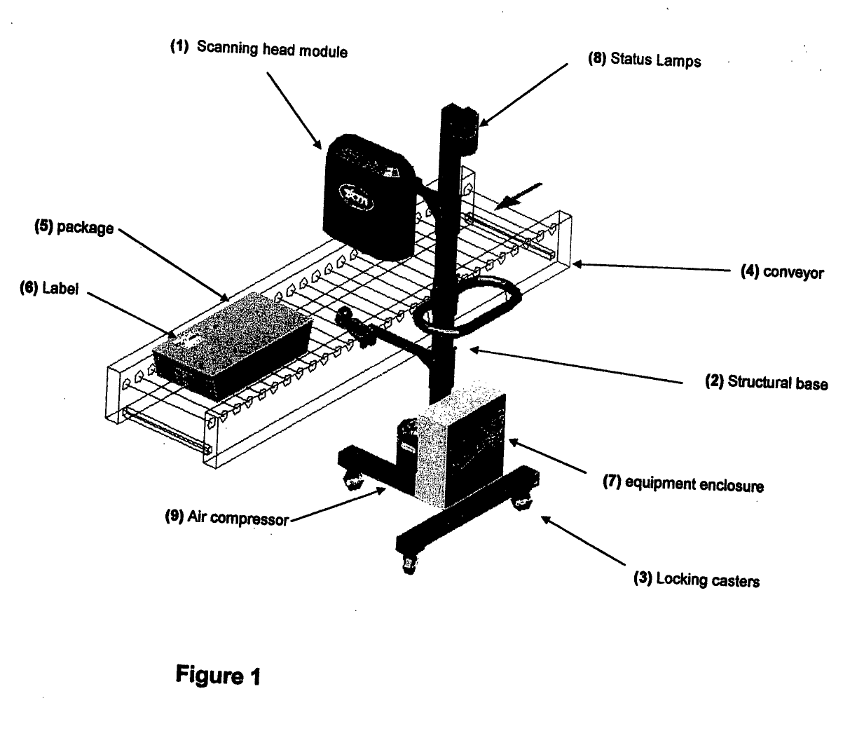

The overall configuration of the machine and its operating position relative to a conveyor and transport package is shown in FIG. 1. The scanning head module (1) is the central component of the tag canceller machine and incorporates the components to identify, locate, and cancel old package labels. It is supported by a structural base (2) which has locking caster (3) to facilitate movement and positioning of the machine in the facility. For operation, the machine is rolled up and positioned next to a conveyor (4) or other transport surface which carries the packages (5) with labels (6) that need to be cancelled.

Other features of the overall machine could include a simple equipment enclosure (7) to provide a central location for power distribution components, fuse protection, on/off power switch and other industrial components typical for portable power equipment. A machine status lamp (8) provides a visual indication that the system is ON and can notify if a fault or other condition is present and operator intervention is needed.

It is envisioned that the machine would be connected to the facility for electrical power and compressed air supply. For convenience the canceling machine could incorporate its own small air compressor (9) which could be used to operate ink-jet sprayers or other marking technologies.

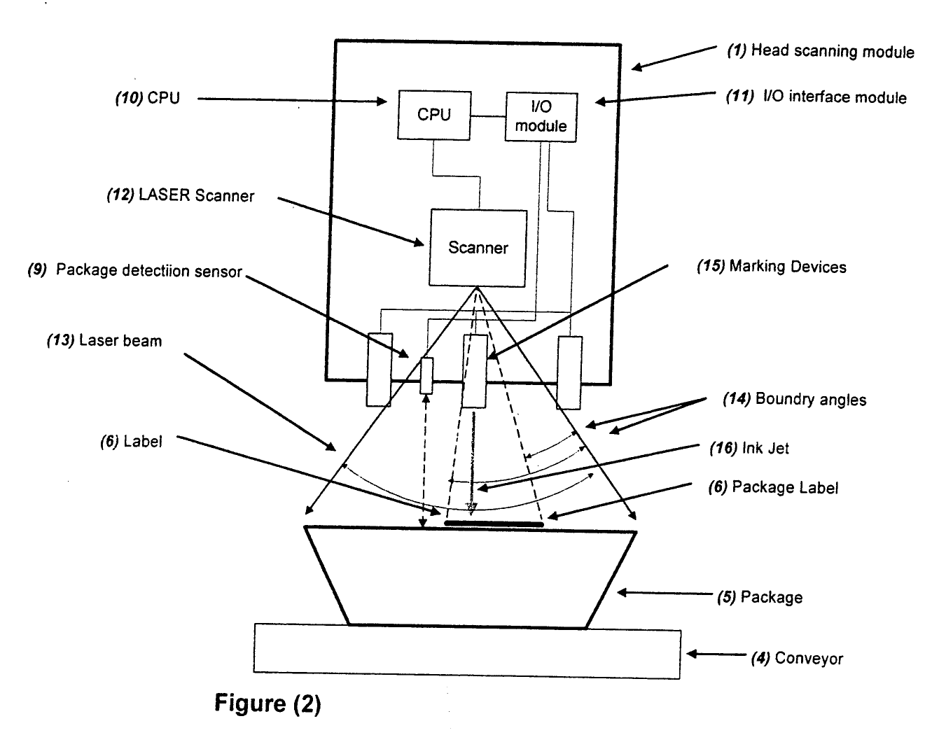

FIG. 2 provides a more detailed look at the components of the scanning head module (1) and how they operate to automatically cancel package labels.

The canceling machine is positioned next to the conveyor (4) with the scanning head module (1) centrally positioned over the package (5) being transported. As the package (5) moves underneath the scanning head module (1), the package sensor (9) detects its presence signals the CPU (10) through the I/O interface module (11). The CPU (10) interfaces directly with the LASER scanner (12), which begins scanning the top of the package (5) with the laser beam (13). The laser beam (13) repeatedly traverses across the top of the package (5) in an approximately crosswise orientation to the direction of travel. The successive sweep of the laser beam (13) combined with the linear motion of the package results in a raster scanning of the entire top surface of the package (5).

The laser scanner (12) monitors the reflected energy of the sweeping laser beam (13) and through software attempts to decode label or barcode information. When information is detected, the laser scanner (12) determines the timing of the sweeping laser beam (13) where the data starts and stops. The timing information is sent to the CPU (10) where software determines the boundary angles (14) of the package label with respect head scanning module (1). From this relative position, the CPU (10) will output signals through the I/O interface module (11) to activate individual marking devices (15) which correspond with the position of the detected label. When activated, the marking devices (15) will render the label unreadable by drawing a line through the information with an inkjet (16) or other technique to mask or otherwise obliterate the information, making it unreadable by subsequent automation.

There are other types of optical sensing technologies, (vision systems or optical sensors) which could be used to sense the label on the package and determine its longitudinal position. A “vision system” approach uses a camera to capture an image of the package surface. Computer processing of the captured image data can then locate the package label and determine its location for subsequent cancellation. This approach has been used successfully however it is generally more expensive and it is very sensitive to the different lighting conditions encountered in the operation environment.

The distance between the head and the package is important for both the optical scanning and the marking process. In some applications the height of the packages may vary widely and this variation may happen from tray to tray. For these applications the head unit would have to automatically adjust in height to maintain the correct head to conveyor distance. We have also made this modification using an optical trigger and a pneumatic cylinder to raise and lower the head automatically.

While the preferred embodiment of the invention has been described, it will be apparent to those skilled in the art that various modifications may be made to the embodiment without departing from the spirit of the present invention. Such modifications are all within the scope of the present invention.

1. An automatic label canceling machine to cancel old labels and barcodes of a package on a transport system, comprising:
a structural base placed near a transport system, on which a package having a label to be rendered unreadable is conveyed; and
a scanning head module positioned over said transport system at a height to permit said package to pass, having:
an array of marker to render label on a package over a transport system unreadable,
an optical scanner used to look for information on said label, wherein the transverse position of said label across said transport system is determined if said information is found, and
an electronic control unit which interfaces to said optical scanner and activates said array of marker for each said label detected on said package, wherein the timing and duration to activate said array of marker is determined.

2. The automatic label canceling machine, wherein said transport system is a conveyor.

3. The automatic label canceling machine as described in claim 1, wherein said marker is selected from the group consisting of ink-jet sprayer, laser and other marker technology.

4. The automatic label canceling machine as described in claim 1, wherein said marker array is positioned downstream from said optical scanner.

5. The automatic label canceling machine as described in claim 1, further comprising a switch to suspend operation of said machine when said package is jammed on the transport system.

6. The automatic label canceling machine as described in claim 1, wherein said label is a barcode.

7. The automatic label canceling machine as described in claim 1, wherein said machine can be rolled up and positioned adjacent said transport system.

8. The automatic label canceling machine as described in claim 1, wherein a structural base has a locking caster to facilitate movement and positioning the machine next to said transport system.

9. The automatic label canceling machine as described in claim 1, further comprising an equipment enclosure to provide central location for power distribution components, fuse protection, on/off switch and other industrial components typical for portable power equipment.

10. The automatic label canceling machine as described in claim 1, further comprising a machine status lamp to provide a visual indication that the machine is on, and can notify if a fault is present and operator intervention is needed.

11. The automatic label canceling machine as described in claim 1, wherein said optical scanner is a laser scanner.

12. The automatic label canceling machine as described in claim 11 wherein said laser scanner detects the presence of said information and signals a central processing unit (CPU) through an interface module, and wherein said CPU interfaces directly with said laser scanner which raster scans repeatedly the package crosswise orientation to the package movement.

13. The automatic label canceling machine as described in claim 12,
wherein said laser scanner monitors a sweeping laser beam, decodes said information on said label, and determines the timing of the laser beam when to start and to stop, and
wherein the information of said timing is sent to said CPU to determine the boundary angles of the package label, and
wherein said CPU output signals through an I/O interface module to activate said marker.

14. The automatic label canceling machine as described in claim 1, further comprising an air compressor to operate said marker.

15. The automatic label canceling machine as described in claim 1, wherein the height of said scanning head module automatically adjusts to accommodate a mixed stream of different height said package.

16. The automatic label canceling machine as described in claim 12, wherein said label is detected and its position determined by numerical processing of an image which contains corresponding said label.
